(19) United States
(12) Patent Application Publication
(10) Pub. No.: US 2025/0371391 A1
(43) Pub. Date: Dec. 4, 2025

(54) INFERENCE GENERATION USING TRANSFORMED INPUT DATA AND AN INPUT DATA ATTACK RESISTANT INFERENCE MODEL

(71) Applicant: Dell Products L.P., Round Rock, TX (US)

(72) Inventors: OFIR EZRIELEV, Beer Sheva (IL); TOMER KUSHNIR, Omer (IL); AMIHAI SAVIR, Newton, MA (US)

(21) Appl. No.: 18/678,546

(22) Filed: May 30, 2024

(51) Int. Cl. G06N 5/046; G06N 3/045

(52) U.S. Cl. CPC G06N 5/046; G06N 3/045

(57) ABSTRACT

Methods and systems for managing use of inference models are disclosed. To manage use of inference models, transformed input data may be obtained, the transformed input data being generated using input data and a one-way function to reduce a level of sensitivity of the input data and the level of sensitivity indicating a level of impact of unauthorized access to the input data. A reconstruction resistant inference may be generated using the transformed input data and an input data attack resistant inference model. The input data attach resistant inference model may be trained to ingest the transformed input data so that inferences generated by the input data attack resistant inference model have a reduced likelihood of being usable to reconstruct the input data. Computer-implemented services may be provided based on the reconstruction resistant inference.

### FIELD

Embodiments disclosed herein relate generally to managing use of inference models. More particularly, embodiments disclosed herein relate to systems and methods to manage use of input data attack resistant inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram illustrating a neural network in accordance with an embodiment.

FIGS. 2B-2C show diagrams illustrating data flows in accordance with an embodiment.

FIGS. 3A-3C show flow diagrams illustrating methods for managing use of inference models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing use of inference models. Inferences generated by the inference models may be used to provide computer-implemented services. The computer-implemented services may include any quantity and type of such services.

To provide a desired type and/or quantity of the computer-implemented services, an inference model may ingest input data that is private, confidential, and/or otherwise restricted for access by entities throughout a distributed system. The input data may include, for example, personal identifiable information (PII) for individuals and/or other types of data which may exhibit a level of sensitivity, the level of sensitivity indicating a level of impact of unauthorized access to the input data.

To generate the inferences and provide, at least in part, the computer-implemented services, the input data and/or the inference model may be deployed to a location where inferences are desired to be generated. However, the location may be vulnerable to compromise by unauthorized entities (e.g., malicious entities) that may attempt to gain access to the input data. The location may be vulnerable to compromise due to: (i) potential compromise of hardware resources of data processing systems at the location, (ii) network security concerns, (iii) differing data privacy regulations, and/or (iv) other reasons. Access to the input data by unauthorized entities may result in undesirable consequences (e.g., data privacy violations, identity theft, access to bank account information, access to confidential medical information).

To provide the computer-implemented services while reducing a likelihood that input data may be accessed and/or reconstructed using the inferences by unauthorized entities, an input data attack resistant inference model may be deployed and used to perform inference generation. The input data attack resistant inference model may be trained to generate inferences using transformed input data, which may be resistant to reconstruction of the untransformed input data (e.g., via transformation using a one-way function). Therefore, protected input data may be more likely to be obfuscated during inference generation and/or providing the input data to a location which hosts the inference model may be compliant with data privacy regulations.

The input data attack resistant inference model may be generated using a co-training process, during which a first training dataset may be used to train a first portion of a neural network inference model and a second training dataset (e.g., a transformed first training dataset) may be used to train a second portion of a neural network inference model. The first portion and the second portion of the neural network inference model may be optimized so that output from the first portion and output from the second portion substantially match. The second portion of the neural network inference model may then be used as the input data attack resistant inference model to generate inferences using transformed input data.

Thus, embodiments disclosed herein may address, among other technical problems, the technical challenge of protecting input data used by an inference model to generate inferences. By using transformed input data to generate inferences, the input data may not be provided to the location which hosts the inference model. By doing so, computer-implemented services may be provided using input data which may exhibit a level of sensitivity while reducing a likelihood that the input data is accessed by an unauthorized entity.

In an embodiment, a method for managing use of inference models is disclosed. The method may include: obtaining transformed input data, the transformed input data being generated using input data and a one-way function to reduce a level of sensitivity of the input data and the level of sensitivity indicating a level of impact of unauthorized access to the input data; generating, using the transformed input data and an input data attack resistant inference model, a reconstruction resistant inference, the input data attack resistant inference model being trained to ingest the transformed input data so that inferences generated by the input data attack resistant inference model have a reduced likelihood of being usable to reconstruct the input data; and providing computer-implemented services based on the reconstruction resistant inference.

The method may also include: prior to obtaining the transformed input data: obtaining a first training dataset, the first training dataset including a set of input features and labels for the input features; obtaining a second training dataset, the second training dataset including transformed input features and the labels, the transformed input features being generated using the set of the input features and the one-way function; performing a co-training process for a neural network inference model using the first training dataset and the second training dataset, the neural network inference model including: a first portion of the neural network inference model, the first portion being trained using the first training dataset to predict the labels; and a second portion of the neural network inference model, the second portion being trained using the second training dataset to predict the labels; and using the second portion of the neural network inference model as the input data attack resistant inference model.

Performing the co-training process may include: performing an optimization process for the first portion of the neural network inference model and the second portion of the neural network inference model using an objective function to obtain an updated set of weights for the neural network inference model.

The updated set of weights may be optimized so that output generated by the first portion of the neural network inference model and output generated by the second portion of the neural network inference model substantially match.

The one-way function may be a hash function.

The method may also include: prior to obtaining the transformed input data: identifying an occurrence of an inference model deployment event for a location; based on the occurrence, making a determination regarding whether the location is trustworthy; in a first instance of the determination in which the location is not trustworthy: selecting, from a model repository, the input data attack resistant inference model rather than a non-input data attack resistant inference model; and initiating deployment of the input data attack resistant inference model to the location.

The location may have access to the transformed input data and may not have access to the input data.

The model repository may include: at least one input data attack resistant inference model; and at least one non-input data attack resistant inference model.

The input data attack resistant inference model may be hosted by a first device and the transformed input data may be obtained by the first device from a second device, the second device being located remote to the first device.

An inference generated by a non-input data attack resistant inference model using the input data may substantially match the reconstruction resistant inference generated by the input data attack resistant inference model using the transformed input data.

The non-input data attack resistant inference model may be trained using a first training dataset that relates a set of input features to labels and the input data attack resistant inference model may be trained using at least a second training dataset that relates transformed input features to the labels, the set of the transformed input features being generated using the set of the input features and the one-way function.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

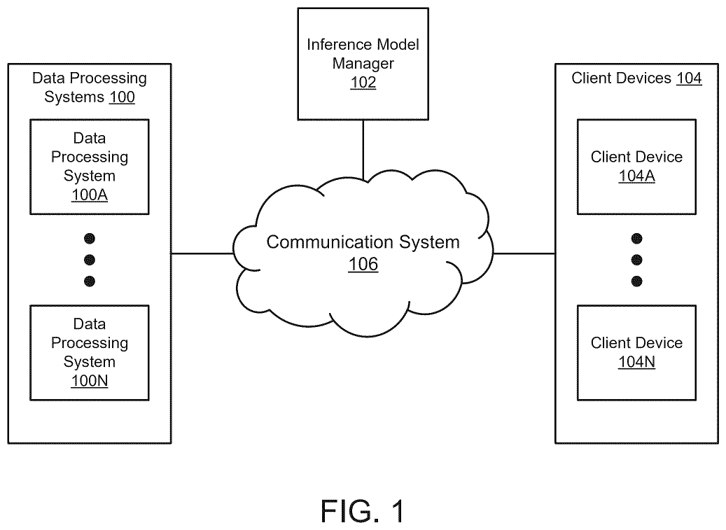

Turning to FIG. 1, a block diagram illustrating a system in accordance with an embodiment is shown. The system shown in FIG. 1 may provide computer-implemented services. The computer-implemented services may include, for example, database services, instant messaging services, and/or other types of computer-implemented services. The computer-implemented services may be provided by any number of devices (e.g., data processing systems 100, client devices 104). The devices may provide similar and/or different computer-implemented services. Data processing systems 100, client devices 104, and/or other devices (not shown) may utilize the computer-implemented services. Other types of computer-implemented services may be provided by the system shown in FIG. 1 without departing from embodiments disclosed herein.

The system may include any number and/or type of data processing systems (e.g., 100A-100N). Data processing systems 100 may provide data services for other devices operably connected to data processing systems 100 (e.g., client devices 104). To provide the data services, data processing systems 100 may include hardware and/or software components configured to obtain data, store data, transform data, provide data to other devices, and/or perform any other task to facilitate performance of the data services.

Data from data processing systems 100 may be used as input data by one or more inference models to generate inferences as output used to provide the computer-implemented services. The content of the input and the output may depend on the goal of the inference models, the architecture of the inference models, and/or other factors.

As part of providing the computer-implemented services, the inference models may be deployed (e.g., by inference model manager 102) to a device (e.g., client device 104A) to perform inference generation using the input data (e.g., from data processing system 100A).

However, the inferences used to provide the computer-implemented services may be based on input data that is private, confidential, and/or otherwise restricted for access by entities throughout a distributed system. For example, the input data may include personally identifiable information (PII), proprietary information from an organization, medical data for an individual, and/or other types of sensitive data.

For example, client device 104A may be a data processing system used by a healthcare company to provide medical diagnostic services. The medical diagnostic services may include generating inferences regarding whether a patient is likely suffering from a disease using the patient's medical data as input. To provide the medical diagnostic services, client device 104A may obtain the patient's medical data from a data processing system located at a hospital (e.g., data processing system 100A). While the users of data processing system 100A may be authorized to access the patient's medical data (e.g., doctors, nurses), users of client device 104A may not be authorized to access the medical data (e.g., data scientists, engineers).

Because the users of client device 104A may not be authorized to access the patient's medical data, the hospital may be unable to provide any and/or all of the patient's medical data to the healthcare company due to data regulations (e.g., hospital privacy policies, data confidentiality policies enacted by a governing entity). Thus, due to the data regulations and the sensitivity of data, client device 104A may be unable to provide any and/or a portion of the computer-implemented services.

In general, embodiments disclosed herein may provide methods, systems, and/or devices for providing inference model management services in a manner that reduces a likelihood that confidential and/or otherwise sensitive input data is accessed by unauthorized entities. To do so, the input data may be transformed using a one-way function prior to use in inference generation. Consequently, the transformed input data may be provided to devices and/or other entities which may not be authorized to access the input data, allowing the input data to be protected while providing the computer-implemented services.

To provide the inference model management services, a system in accordance with an embodiment may determine whether a location is trustworthy (e.g., may be authorized to access the input data). The location may not be considered trustworthy if the location is potentially vulnerable to compromise and/or if the location is subject to different data privacy regulations than an input data source location.

If the location is determined to not be trustworthy, an input data attack resistant inference model may be selected and deployed for use in inference generation. The input data attack resistant inference model may be trained to generate inferences using transformed input data. The transformed input data may be generated using the input data and a one-way function (e.g., a perfect hash function), which may allow the input data to be transformed without losing information.

Once deployed to the location, the input data attack resistant inference model may obtain transformed input data from a remote device to use as ingest for inference generation. The inferences generated using the input data attack resistant inference model and transformed input data may be substantially the same as inferences generated using a non-input data attack resistant inference model and input data.

By doing so, inferences based on transformed input data may be generated which are substantially of the same quality as inferences based on untransformed input data while restricting access to the input data. Therefore, the computer-implemented services using inferences based on the input data may be provided in a manner that maintains the desired quality, reliability, and/or availability of the computer-implemented services while protecting the input data.

To perform the above-noted functionality, the system of FIG. 1 may include data processing systems 100, inference model manager 102, and/or client devices 104. Data processing systems 100, inference model manager 102, client devices 104, and/or any other type of devices not shown in FIG. 1 may perform all, or a portion of the computer-implemented services independently and/or cooperatively. Each of these components is discussed below.

Client devices 104 may include any number of and/or type of devices (e.g., 100A-100N) which may be used to provide all, or a portion, of the computer-implemented services. To provide the computer-implemented services, client devices 104 may host any number of inference models which may generate inferences using ingest data obtained from other devices (e.g., data processing systems 100). For example, client devices 104 may provide database services, instant messaging services, and/or any other type of services using inferences generated by inference models while providing the computer-implemented services. The inferences may be generated by any type of inference model, such as an input data attack resistant inference model.

Data processing systems 100 may include any number and/or type of data processing systems (e.g., 100A-100N). To perform its functionality, data processing systems 100 may (i) obtain input data from any number of data sources (not shown), (ii) transform the input data (e.g., using a one-way function), (iii) provide the data to other devices (e.g., client devices 104), and/or (iv) perform other actions to participate in the provision of the computer-implemented services by client devices 104 and/or other entities.

For example, a data processing system (e.g., 100A) may manage input data for an input data attack resistant inference model. To manage the input data, data processing system 100A may transform the input data before providing it to another device (e.g., client device 104A) to be used as ingest by an input data attack resistant inference model.

The inference models hosted by client devices 104 may be managed by inference model manager 102. To manage the inference models, inference model manager 102 may (i) obtain training datasets (e.g., from any number of data sources, not shown), (ii) transform and/or process the training datasets (e.g., transform the training datasets using a one-way function, fill data gaps, extract values from the data), (iii) perform training processes to train the inference models (e.g., input data attack resistant inference models, non-input data attack resistant inference models), (iv) select trained inference models to be deployed to locations (e.g., based on the trustworthiness of the location, based on the sensitivity of the input data for the inference model), (v) initiate deployment of the selected trained inference models, and/or (vi) perform other actions to facilitate provision of the computer-implemented services.

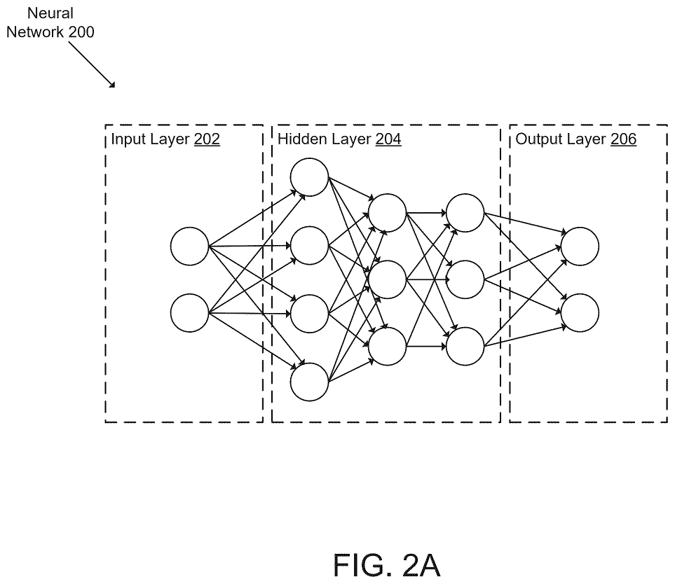

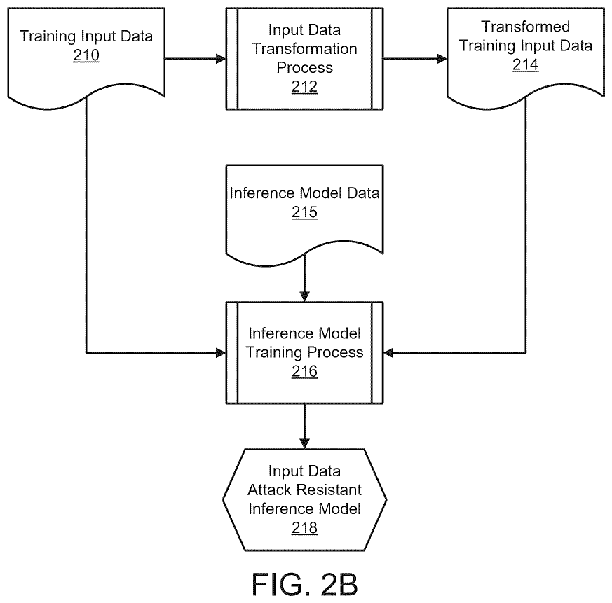

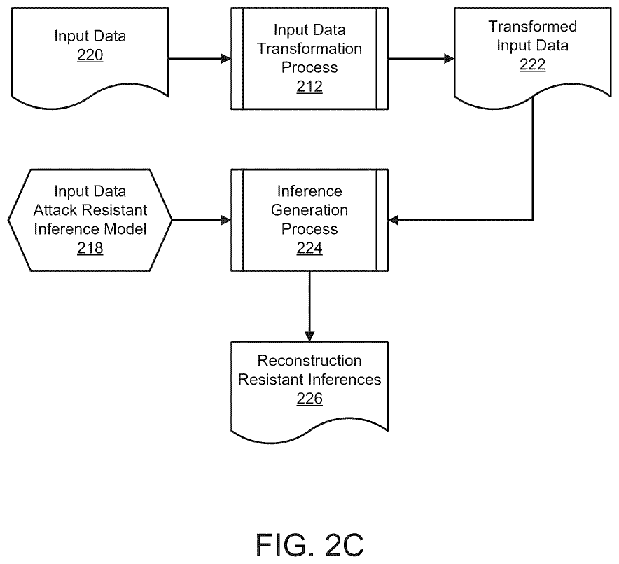

As part of performing the training processes, inference model manager 102 may train any number of input data attack resistant inference models. To train an input data attack resistant inference model, inference model manager 102 may (i) obtain a first training dataset (e.g., from data processing system 100A) including a set of input features and labels for the input features, (ii) obtain a second training dataset by transforming the first dataset (e.g., using a one-way function), the second training dataset including transformed input features and the labels from the first training dataset (e.g., a transformed training dataset), (iii) perform a co-training process for a neural network inference model by training a first portion of the neural network inference model using the first training dataset to predict the labels and a second portion of the neural network inference model using a second training dataset to predict the labels, and/or (iv) perform other actions to train the input data attack resistant inference model. The second portion of the trained neural network inference model may be used as the input data attack resistant inference model. Refer to FIG. 2B for additional details regarding training input data attack resistant inference models.

Thus, inference model management services may be provided by inference model manager 102. By doing so, input data attack resistant inference models may be trained using a training dataset and a transformed training dataset, which may allow inferences to be generated by the input data attack resistant inference model using transformed input data. The use of transformed input data to generate inferences may allow for computer-implemented services to be provided (e.g., by client devices 104) while protecting the input data.

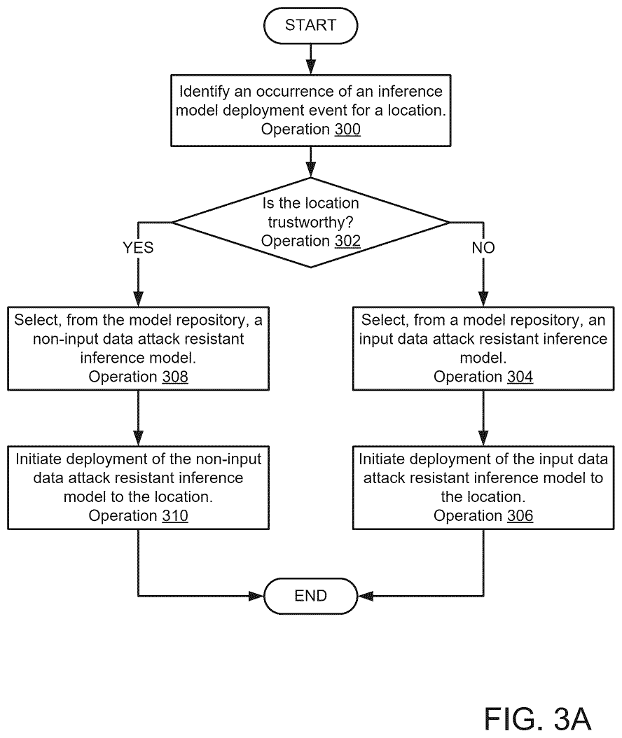

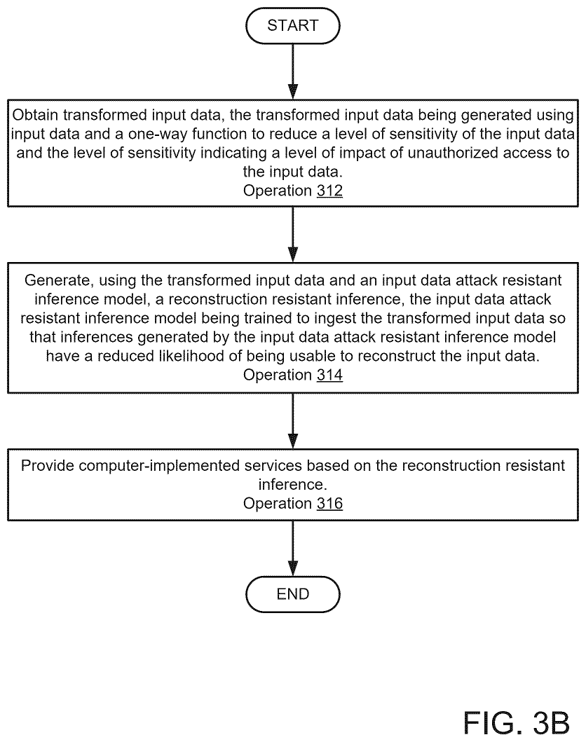

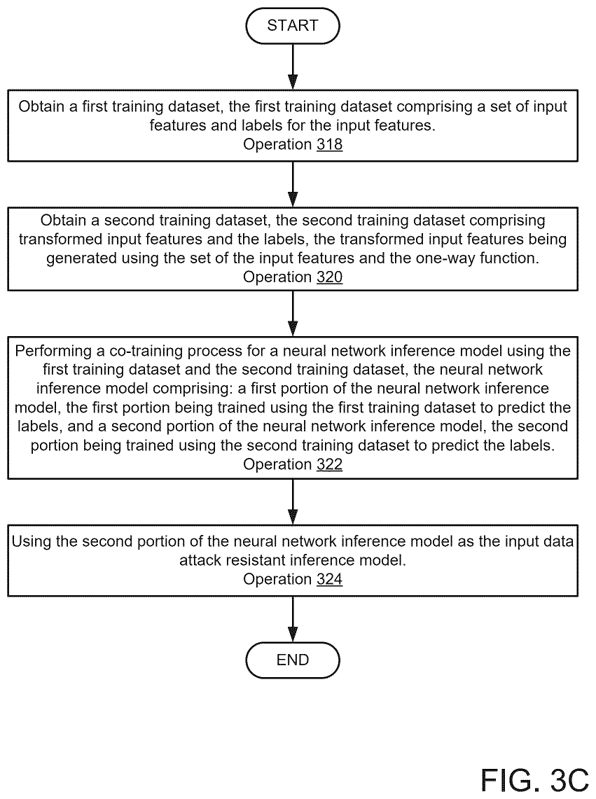

When providing their functionality, data processing systems 100, inference model manager 102, and/or client devices 104 may perform all, or a portion, of the methods and/or actions described in FIGS. 2A-3B.

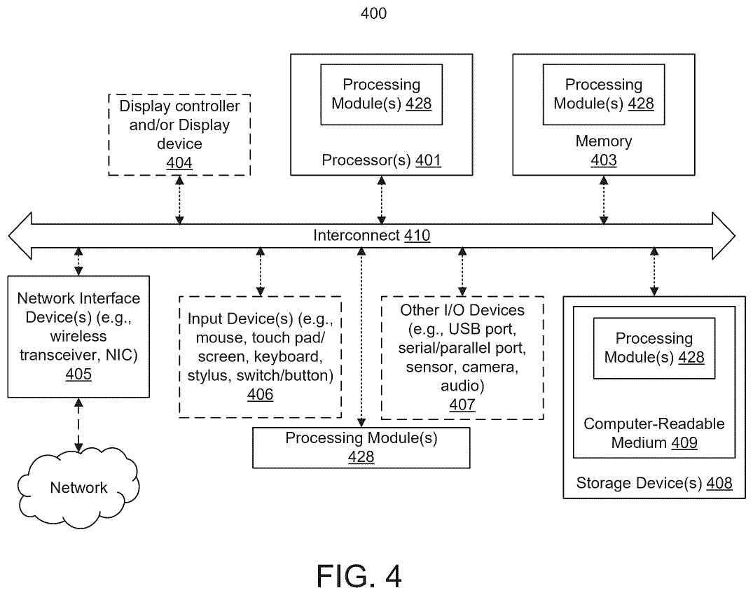

Data processing systems 100, inference model manager 102, and/or client devices 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein. For example, while the system of FIG. 1 shows a single inference model manager (e.g., 102), it will be appreciated that the system may include any number of inference model managers.

To further clarify embodiments disclosed herein, an inference model diagram in accordance with an embodiment is shown in FIG. 2A. The inference model diagram may illustrate a structure of the inference models and/or how data is processed/used within the system of FIG. 1.

Turning to FIG. 2A, a diagram illustrating a neural network (e.g., an implementation of an inference model) in accordance with an embodiment is shown.

In FIG. 2A, neural network 200 may be similar to any inference model managed by inference model manager 102, discussed above. Neural network 200 may include a series of layers of nodes (e.g., neurons, illustrated as circles). This series of layers may include input layer 202, hidden layer 204 (which may include different sub-layers of neurons), and output layer 206. Lines terminating in arrows in this diagram indicate data relationships (e.g., weights). For example, numerical values calculated with respect to each of the neurons during operation of neural network 200 may depend on the values calculated with respect to other neurons linked by the lines (e.g., the weight associated with each line may impact the level of dependence of the value for a second neuron for the value for neuron from which the line initiates). The value calculated with respect to a first neuron may be based, at least in part, on the values of other neurons from which the arrows that terminate in the neuron initiate from.

Each of the layers of neurons of neural network 200 may include any number of neurons and may include any number of sub-layers.

To generate inference, neural network 200 may require input data. The input data may include confidential information, may include protected medical data, may include PII, and/or may otherwise include data with restricted access. Neural network 200 may be hosted by a device which is not authorized to access the input data, and/or providing the input to the device may result in an unacceptable level of risk (e.g., the level of risk of interception of the input data by an unauthorized entity while providing the input data to the device).

To increase a likelihood that the input data is provided to neural network 200 in a manner which protects the input data from access by an unauthorized entity, embodiments disclosed herein may provide a system and method for managing input data attack resistant inference models. To do so, the system may perform a co-training process using neural network 200. Refer to FIG. 2B for additional details regarding this co-training process.

To further clarify embodiments disclosed herein, data flow diagrams in accordance with an embodiment are shown in FIGS. 2B-2C. In these diagrams, flows of data and processing of data are illustrated using different sets of shapes. A first set of shapes (e.g., 210, 214) is used to represent data structures, a second set of shapes (e.g., 212, 216) is used to represent processes performed using and/or that generate data, and a third set of shapes (e.g., 218) is used to represent trained inference models and/or portions of trained inference models.

Turning to FIG. 2B, a first data flow diagram in accordance with an embodiment is shown. The first data flow diagram may illustrate data used in and data processing performed in training an input data attack resistant inference model.

To train an input data attack resistant inference model, training input data 210 may be obtained. Training input data 210 may include a first training dataset including any type and/or quantity of training data from any number of data sources (not shown). Training input data 210 may include a set of input features and labels for the input features.

For example, an input data attack resistant inference model may be trained to generate diagnostic inferences regarding whether a patient is likely suffering from a disease. To train the input data attack resistant inference model to generate the diagnostic inferences, a first training dataset (e.g., training input data 210) may be obtained. The first training dataset may include training patient medical data (e.g., symptom data, patient demographic data, patient lifestyle data, medical history data from the patient and/or the patient's family) as input features and corresponding information regarding whether the patient suffers from the disease as the labels.

Training input data 210 may be used to perform input data transformation process 212 to generate a second training dataset (e.g., transformed training input data 214). During input data transformation process 212, training input data 210 may be transformed using a one-way function (e.g., a hash function) to obtain transformed training input data 214. The one-way function may be an operation that transforms information from one space to another (e.g., a hash function which maps elements from the input dataset to hash values) in a manner that is more computationally difficult to invert than to compute. The one-way function may retain the informational content of the original input data. For example, the one-way function may be a perfect hash function which maps distinct elements from a dataset to a set of hash values with no collisions (e.g., each hash value corresponds to one element from the dataset).

While described with respect to the one-way function being a hash function, it will be appreciated that the one-way function used to transform the dataset may be any one-way function (and/or any combination of functions resulting in transformation of the data).

Continuing with the above example, a second training dataset may be obtained by transforming the first training dataset using a perfect hash function. By using a perfect hash function, the training patient medical data may be transformed into a second training dataset which includes transformed input features (e.g., hash values representing the symptom data, the patient demographic data, the patient lifestyle data, medical history data from the patient and/or the patient's family) and the same corresponding information regarding whether the patient suffers from the disease as the labels.

After obtaining two training datasets, inference model training process 216 may be performed to obtain a trained input data attack resistant inference model (e.g., input data attack resistant inference model 218). During inference model training process 216, a co-training process for a neural network inference model (e.g., similar to neural network 200, refer to FIG. 2A) may be performed using training input data 210, transformed training input data 214, and inference model data 215. Inference model data 215 may include data regarding the architecture of the neural network, including data regarding the neurons and weights of the neural network.

During the co-training process, a first portion of the neural network inference model may be trained using training input data 210 to predict the labels, and a second portion of the neural network inference model may be trained using transformed training input data 214 to predict the labels.

An optimization process may be performed as part of the co-training process for the first portion of the neural network inference model (e.g., a non-input data attack resistant inference model) and the second portion of the neural network inference model using an objective function to obtain an updated set of weights for the neural network inference model. The updated set of weights may be optimized so that output generated by the first portion of the neural network inference model (e.g., a first output) and output generated by the second portion of the neural network inference model (e.g., a second output) substantially match. For example, the first output may substantially match the second output if a value of the first output is within 5% of a value of the second output.

While described with respect to a 5% difference in a value of the first output and a value of the second output, it will be appreciated that the first output may substantially match the second output based on any other percentage of deviation and/or other metric used to analyze the degree of difference between the outputs as determined, for example, by a subject matter expert (SME) and/or via any other method.

Continuing with the above example, the first training dataset (e.g., including the patient medical data and labels) and the second training dataset (e.g., including the hash values for the patient medical data and the labels) may be used to train an input data attack resistant inference model to generate diagnostic inferences using transformed input data (e.g., the hash values). To do so, a first portion of a neural network inference model may be trained to generate diagnostic inferences using the patient medical data, and a second portion of the neural network inference model may be trained to generate diagnostic inferences using the hash values for the patient medical data. An optimization process using an objective function may be performed so that the diagnostic inferences for the first portion of the neural network inference model substantially match diagnostic inferences for the second portion of the neural network inference model.

For example, the diagnostic inferences may include a percentage indicating a likelihood that a patient suffers from a disease. The neural network inference model may generate inferences regarding a patient's (e.g., patient John) likelihood of suffering from the disease. The first portion of the neural network inference model, using John's patient medical data, may generate an inference indicating John has an 95% probability of suffering from the disease. The second portion of the neural network inference model, using hash values for John's patient medical data, may generate an inference indicating John has an 93% probability of suffering from the disease. The inferences may be considered to substantially match because they are within a 3% difference threshold.

Once output from the first portion of the neural network inference model substantially matches output from the second portion of the neural network inference model, the second portion of the neural network inference model may be considered trained and may be used as the input data attack resistant inference model (e.g., input data attack resistant inference model 218) to generate reconstruction resistant inferences. Reconstruction resistant inferences may include inferences generated using transformed input data resulting in inferences which are unable and/or difficult (to an extent considered acceptable) to be used to recover the (untransformed) input data. For example, the second portion of the neural network inference model trained to generate diagnostic inferences using hash values for patient medical data as input (e.g., transformed input data) may be used as an input data attack resistant inference model.

By performing inference model training process 216, input data attack resistant inference model may be trained to generate reconstruction resistant inferences using transformed input data. The reconstruction resistant inferences generated by input data attack resistant inference model 218 may substantially match inferences generated by a non-input data attack resistant inference model using the input data (e.g., a value from the reconstruction resistant inferences is within 10% of a value from the inferences generated using the input data).

Prior to inference generation, input data attack resistant inference model 218 may be deployed to a location. The location may not have access to the input data (e.g., the untransformed input data). The location may not have access to the input data due to not being trusted by the provider of the input data (e.g., an authorized data processing system, a data source) (not shown). The location may not be trusted to access the input data due to (i) differences in data privacy regulations between the provider of the input data and the location, (ii) network security concerns, (iii) security concerns at the location, and/or (iv) other reasons.

Input data attack resistant inference model 218 may be selected for deployment to the location from a model repository (not shown) if the location is determined to not be trustworthy. The model repository may include any number of inference models, including (i) input data attack resistant inference models, (ii) non-input data attack resistant inference models, and/or any other type of inference models.

Thus, by implementing the data flow shown in FIG. 2B, a system in accordance with embodiments disclosed herein may be used to obtain an input data attack resistant inference model by performing a co-training process. By performing the co-training process, the input data attack resistant inference model may be trained to generate reconstruction resistant inferences using transformed input data, which may protect the input data from unauthorized access.

Turning to FIG. 2C, a second data flow diagram in accordance with an embodiment is shown. The second data flow diagram may illustrate data used in and data processing performed in generating reconstruction resistant inferences using transformed input data and an input data attack resistant inference model.

To generate reconstruction resistant inferences, input data 220 may be obtained. Input data 220 may include confidential information, protected medical information, PII, and/or may otherwise include data with restricted access. Therefore, input data 220 may exhibit a level of sensitivity, and the level of sensitivity may indicate a level of impact of unauthorized access to the input data (e.g., violating data privacy agreements and/or policies, identity left, unauthorized access to bank accounts). For example, a higher level of sensitivity may indicate a more significant impact if the input data were to be accessed by an unauthorized entity. For example, data including an individual's social security number may exhibit a higher level of sensitivity due to the negative impacts resulting from unauthorized access to the social security number (e.g., opening credit cards, gaining access to bank accounts) than data including an individual's contact information (e.g., spam phone calls, phishing emails). To reduce the level of sensitivity, input data transformation process 212 may be performed to obtain transformed input data 222. Refer to FIG. 2B for additional details regarding input data transformation process 212.

For example, input data 220 may include financial data collected by a bank regarding clients of the bank. The financial data may include a client's confidential information, such as their credit history, bank account information, social security number, password, and/or contact information. The bank may provide the financial data to a loan consulting company, which may provide the bank with a loan amount for the client based on the financial data in response. Because of the level of sensitivity of the financial data (e.g., identity theft of the client, unauthorized access to the client's bank account), the bank may transform the financial data using a one-way function prior to providing the financial data to the loan consulting company. The bank may use a hash function (e.g., a perfect hash function) to transform the financial data into transformed financial data. By doing so, if the transformed financial data were to be intercepted while being transmitted to the loan consulting company by a malicious entity, the client's confidential information may be protected.

Once transformed input data 222 has been obtained, inference generation process 224 may be performed. During inference generation process 224, transformed input data 222 may be provided to a data processing system which hosts input data attack resistant inference model 218. Transformed input data 222 may be used as ingest for input data attack resistant inference model 218 (e.g., the input data attack resistant inference model may not receive input data 220). Input data attack resistant inference model 218 may be hosted by a first device, and transformed input data 222 may be provided to the first device from a second device, the second device being located remote to the first device (e.g., the first device may be located at a location determined not to be trustworthy by the second device, refer to FIG. 2B). Input data attack resistant inference model 218 may then generate reconstruction resistant inferences 226 as output.

Continuing with the above example, the bank may provide the transformed financial data to a device (e.g., a data processing system) used by the loan consulting company which hosts an input data attack resistant inference model. The input data attack resistant inference model may use the transformed financial data to generate a loan amount for the client as output. Doing so may decrease a likelihood that the untransformed financial data (e.g., a reconstruction resistant inference) may be reconstructed by a malicious entity. The loan amount generated by the input data attack resistant inference model may substantially match a loan amount that would be generated by a non-input data attack resistant inference model using the untransformed financial data as input.

Thus, by implementing the data flow shown in FIG. 2C, a system in accordance with embodiments disclosed herein may generate reconstruction resistant inferences using transformed input data and an input data attack resistant inference model. By generating reconstruction resistant inferences using transformed input data, inference generation may be performed at an untrustworthy location with a reduced risk of unauthorized access to the untransformed input data.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components and/or data structures of FIG. 1 may perform various methods to provide inference model management services in a manner that protects input data during inference generation. FIGS. 3A-3B illustrate methods that may be performed by the components of FIG. 1. In the diagrams discussed below and shown in these figures, any of the operations may be repeated, performed in different orders, omitted, and/or performed in parallel and/or a partially overlapping in time manner with other operations.

Turning to FIG. 3A, a first flow diagram illustrating a method of managing use of inference models in accordance with an embodiment is shown. In FIG. 3A, the method of managing use of inference models may include selecting and deploying an inference model to a location. The method may be performed, for example, by a data processing system, a client device, an inference model manager, cooperatively by multiple devices throughout a distributed system, and/or other components and/or data structures illustrated in FIGS. 1-2C.

At operation 300, an occurrence of an inference model deployment event for a location may be identified. Identifying the occurrence of an inference model deployment event may include (i) receiving a notification (e.g., via a message over a communication system, via user input to a graphical user interface) that the inference model deployment event has occurred, (ii) reading a notice of the occurrence of the inference model deployment event from storage (e.g., from inference model deployment schedule), and/or (iii) other methods. Identifying the occurrence of the inference model deployment event may also include obtaining an identifier for the location (e.g., from the notification, from storage, from the location).

At operation 302, it may be determined whether the location is trustworthy. Determining whether the location is trustworthy may include: (i) identifying any data privacy regulations (e.g., general data protection regulations (GDPR)) that the location is subject to, (ii) obtaining telemetry data for the location indicating a security posture for the location, (iii) obtaining a level of trust for a communication channel utilized by the location, and/or (iv) other methods.

Determining whether the location is trustworthy may also include comparing the information obtained about the location (e.g., security posture, data privacy regulations) to trustworthiness criteria. The trustworthiness criteria may indicate security requirements (and/or other requirements) that must be satisfied for the location to be considered trustworthy.

For example, input data desired to be used for inference generation may be subject to GDPR and the location may be in a geographical location that is not subject to GDPR. Therefore, the trustworthiness criteria may indicate that the location must be subject to GDPR and, consequently, the location may be determined to be untrustworthy.

In a second example, the input data desired to be used for inference generation may include protected medical information for individuals. Due to data privacy concerns, the location may not be considered trustworthy to receive the input data via a communication channel.

If the location is not determined to be trustworthy (e.g., the determination is “No” at operation 302), the method may proceed to operation 304.

At operation 304, an input data attack resistant inference model may be selected from a model repository. Selecting the input data attack resistant inference model may include (i) identifying a set of features of the input data attack resistant inference model (e.g., based on a desired type and/or quantity of inference, based on a computational resource requirement to operate the inference model), (ii) utilizing the set of features of the input data attack resistant inference model to search the model repository (e.g., using search terms, using a lookup process) to identify the input data attack resistant inference model, and/or (iii) other methods.

Selecting the input data attack resistant inference model may also include providing the set of features to another entity responsible for identifying the input data attack resistant inference model and receiving the input data attack resistant inference model (and/or an identifier for the input data attack resistant inference model) from the entity.

At operation 306, deployment of the input data attack resistant inference model to the location may be initiated. Initiating deployment of the input data attack resistant inference model may include (i) transmitting the input data attack resistant inference model to the location, (ii) storing the input data attack resistant inference model in storage shared with the location for subsequent retrieval by the location, and/or (iii) other methods. Initiating deployment of the input data attack resistant inference model to the location may also include providing instructions to another entity responsible for managing deployment of the input data attack resistant inference model to the location.

The method may end following operation 306.

Returning to operation 302, if the location is determined to be trustworthy (e.g., the determination is “Yes” at operation 302), the method may proceed to operation 308.

At operation 308, a non-input data attack resistant inference model may be selected from the model repository. The non-input data attack resistant inference model may be selected due to (i) a lower computational cost for hosting and/or operating the non-input data attack resistant inference model, (ii) input data used to generate inferences does not exhibit a level of sensitivity, (iii) it is determined that the location meets data privacy regulations, and/or (iv) other reasons.

For example, an input data attack resistant inference model may be more computationally costly to train, host, and operate than the non-input data attack resistant inference model. Therefore, the non-input data attack resistant inference model may be selected if the location is trustworthy and, consequently, a more computationally costly inference model is not requested to proceed with inference generation at the location.

Selecting the non-input data attack resistant inference model may include methods similar to those described with respect to operation 304.

At operation 310, deployment of the non-input data attack resistant inference model to the location may be initiated. Initiating deployment of the inference model to the location may include methods similar to those described with respect to operation 306.

The method may end following operation 310.

Therefore, the method described in FIG. 3A may be used to deploy inference models to locations where inferences are desired to be generated. Input data attack resistant inference models may be deployed if data privacy concerns and/or data security concern are identified for the location. By doing so, a likelihood that a malicious entity may access protected and/or private input data may be reduced.

Turning to FIG. 3B, a second flow diagram illustrating a method of managing use of inference models in accordance with an embodiment is shown. In FIG. 3B, the method of managing use of the inference models may include generating reconstruction resistant inferences using an input data attack resistant inference model. The method may be performed, for example, by a data processing system, a client device, an inference model manager, cooperatively by multiple devices throughout a distributed system, and/or other components and/or data structures illustrated in FIGS. 1-2C.

At operation 312, transformed input data may be obtained, the transformed input data being generated using input data and a one-way function to reduce a level of sensitivity of the input data and the level of sensitivity indicating a level of impact of unauthorized access to the input data. Obtaining the transformed input may include (i) obtaining input data (e.g., generating the input data, receiving the input data from another device, reading the input data from storage), (ii) transforming the input data, (iii) providing the transformed input data to a device which hosts an input data attack resistant inference model, and/or (iv) other methods.

Transforming the input data may include (i) selecting a one-way function to transform the input data (e.g., a hash function), (ii) inputting the input data into the one-way function, (iii) generating transformed input data as output from the one-way function, and/or (iv) other methods.

At operation 314, a reconstruction resistant inference may be generated using the transformed input data and an input data attack resistant inference model, the input data attack resistant inference model being trained to ingest the transformed input data so that inferences generated by the input data attack resistant inference model have a reduced likelihood of being usable to reconstruct the input data. Generating the reconstruction resistant inference may include (i) obtaining instructions indicating that the transformed input data is to be fed into an input layer of the input data attack resistant inference model neural network, (ii) feeding the transformed input data into the input layer, (iii) generating the reconstruction resistant inference as output, and/or (iv) other methods.

At operation 316, computer-implemented services may be provided based on the reconstruction resistant inference. Providing the computer-implemented services may include (i) making a decision based at least in part on the reconstruction resistant inference, (ii) identifying a type and/or quantity of service to provide to a particular user based at least in part on the reconstruction resistant inference, (iii) providing the reconstruction resistant inference to another entity responsible for providing the computer-implemented services, and/or (iv) other methods.

The method may end following operation 316.

Therefore, the method described in FIG. 3B may be used to generate reconstruction resistant inferences using transformed input data as ingest for an input data attack resistant inference model. By doing so, a likelihood that a malicious entity may access the input data and/or reconstruct protected and/or private input data using inferences generated by the input data attack resistant inference model may be reduced.

Turning to FIG. 3C, a third flow diagram illustrating a method of managing use of inference models in accordance with an embodiment is shown. In FIG. 3C, the method of managing use of the inference models may include a training process for an input data attack resistant inference model. The method may be performed, for example, by a data processing system, a client device, an inference model manager, cooperatively by multiple devices throughout a distributed system, and/or other components and/or data structures illustrated in FIGS. 1-2C.

At operation 318, a first training dataset may be obtained, the first training dataset including a set of input features and labels for the input features. Obtaining the first training dataset may include (i) generating the first training dataset, (ii) receiving the first training dataset from another device, (iii) reading the first training dataset from storage, and/or (iv) other methods.

At operation 320, a second training dataset may be obtained, the second training dataset including transformed input features and the labels, the transformed input features being generated using the set of input features and the one-way function. Obtaining the second training dataset may include (i) selecting a one-way function (e.g., a hash function), (ii) using the first training dataset as input for the one-way function, (iii) obtaining the second training dataset as output of the one-way function, (iv) providing the first training dataset to another device responsible for transforming the first training dataset and receiving the second training dataset in response, and/or (v) other methods.

At operation 322, a co-training process for a neural network inference model may be performed using the first training dataset and the second training dataset. The neural network inference model may include: a first portion of the neural network inference model, the first portion being trained using the first training dataset to predict the labels, and a second portion of the neural network, the second portion being trained using the second training dataset to predict the labels. Performing the co-training process may include (i) performing an optimization process for the first portion of the neural network inference model and the second portion of the neural network inference model using an objective function to obtain an updated set of weights for the neural network inference model, (ii) providing the first portion of the neural network inference model and the second portion of the neural network inference model to another device responsible for performing the co-training process, and/or (iii) other methods.

Performing the optimization process may include (i) defining an objective function in terms of the training datasets and predictions made by each portion of the neural network inference model, (ii) obtaining an updated set of weights for the neural network inference model (e.g., identifying parameters that most faithfully reproduce the trends in the training datasets) using a global optimization method such as gradient descent so that output generated by the first portion of the neural network inference model and output generated by the second portion of the neural network inference model substantially match (e.g., deviation in a value from the output of each portion of the neural network inference model falls within a threshold), (iii) providing the training datasets and the neural network inference model to another entity device responsible for performing the optimization process, and/or (iv) other methods.

At operation 324, the second portion of the neural network inference model may be used as the input data attack resistant inference model. Using the second portion of the neural network inference model as the input data attack resistant inference model may include (i) deploying the input data attack resistant inference model to a location, (ii) obtaining transformed input data (e.g., from a data processing system located at a second location remote to the location), (ii) using the transformed input data as ingest to generate reconstruction resistant inferences, (iii) providing computer-implemented services using the reconstruction resistant inferences, and/or (iv) other methods.

The method may end following operation 324.

Therefore, an input data attack resistant inference model may be trained using a first training dataset and a second training dataset including a transformed first training dataset. The first training dataset may be used to train a first portion of a neural network inference model, and the second training dataset may be used to train a second portion of a neural network inference model. The first portion of the neural network inference model and the second portion of the neural network inference model may be trained to generate inferences which substantially match. By doing so, the second portion of the neural network inference model may be used as an input data attack resistant inference model, which may generate reconstruction resistant inferences using transformed input data.

Using the methods illustrated in FIGS. 3A-3C, embodiments disclosed herein may facilitate management of inference models which may reduce the likelihood of unauthorized access to input data which may exhibit a level of sensitivity.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing use of inference models, the method comprising:
obtaining transformed input data, the transformed input data being generated using input data and a one-way function to reduce a level of sensitivity of the input data and the level of sensitivity indicating a level of impact of unauthorized access to the input data;
generating, using the transformed input data and an input data attack resistant inference model, a reconstruction resistant inference, the input data attack resistant inference model being trained to ingest the transformed input data so that inferences generated by the input data attack resistant inference model have a reduced likelihood of being usable to reconstruct the input data; and
providing computer-implemented services based on the reconstruction resistant inference.

2. The method of claim 1, further comprising:
prior to obtaining the transformed input data:
obtaining a first training dataset, the first training dataset comprising a set of input features and labels for the input features;
obtaining a second training dataset, the second training dataset comprising transformed input features and the labels, the transformed input features being generated using the set of the input features and the one-way function;
performing a co-training process for a neural network inference model using the first training dataset and the second training dataset, the neural network inference model comprising:
a first portion of the neural network inference model, the first portion being trained using the first training dataset to predict the labels; and
a second portion of the neural network inference model, the second portion being trained using the second training dataset to predict the labels; and
using the second portion of the neural network inference model as the input data attack resistant inference model.

3. The method of claim 2, wherein performing the co-training process comprises:
performing an optimization process for the first portion of the neural network inference model and the second portion of the neural network inference model using an objective function to obtain an updated set of weights for the neural network inference model.

4. The method of claim 3, wherein the updated set of weights is optimized so that output generated by the first portion of the neural network inference model and output generated by the second portion of the neural network inference model substantially match.

5. The method of claim 1, wherein the one-way function is a hash function.

6. The method of claim 1, further comprising:
prior to obtaining the transformed input data:
identifying an occurrence of an inference model deployment event for a location;
based on the occurrence, making a determination regarding whether the location is trustworthy;
in a first instance of the determination in which the location is not trustworthy:
selecting, from a model repository, the input data attack resistant inference model rather than a non-input data attack resistant inference model; and
initiating deployment of the input data attack resistant inference model to the location.

7. The method of claim 6, wherein the location has access to the transformed input data and does not have access to the input data.

8. The method of claim 6, wherein the model repository comprises:
at least one input data attack resistant inference model; and
at least one non-input data attack resistant inference model.

9. The method of claim 1, wherein the input data attack resistant inference model is hosted by a first device and the transformed input data is obtained by the first device from a second device, the second device being located remote to the first device.

10. The method of claim 1, wherein an inference generated by a non-input data attack resistant inference model using the input data substantially matches the reconstruction resistant inference generated by the input data attack resistant inference model using the transformed input data.

11. The method of claim 10, wherein the non-input data attack resistant inference model is trained using a first training dataset that relates a set of input features to labels and the input data attack resistant inference model is trained using at least a second training dataset that relates transformed input features to the labels, the set of the transformed input features being generated using the set of the input features and the one-way function.

12. A non-transitory machine-readable medium having instructions stored therein, which when executed by a processor, cause the processor to perform operations for managing use of inference models, the operations comprising:
obtaining transformed input data, the transformed input data being generated using input data and a one-way function to reduce a level of sensitivity of the input data and the level of sensitivity indicating a level of impact of unauthorized access to the input data;
generating, using the transformed input data and an input data attack resistant inference model, a reconstruction resistant inference, the input data attack resistant inference model being trained to ingest the transformed input data so that inferences generated by the input data attack resistant inference model have a reduced likelihood of being usable to reconstruct the input data; and
providing computer-implemented services based on the reconstruction resistant inference.

13. The non-transitory machine-readable medium of claim 12, wherein the operations further comprise:
prior to obtaining the transformed input data:
obtaining a first training dataset, the first training dataset comprising a set of input features and labels for the input features;
obtaining a second training dataset, the second training dataset comprising transformed input features and the labels, the transformed input features being generated using the set of the input features and the one-way function;
performing a co-training process for a neural network inference model using the first training dataset and the second training dataset, the neural network inference model comprising:
a first portion of the neural network inference model, the first portion being trained using the first training dataset to predict the labels; and
a second portion of the neural network inference model, the second portion being trained using the second training dataset to predict the labels; and
using the second portion of the neural network inference model as the input data attack resistant inference model.

14. The non-transitory machine-readable medium of claim 13, wherein performing the co-training process comprises:
performing an optimization process for the first portion of the neural network inference model and the second portion of the neural network inference model using an objective function to obtain an updated set of weights for the neural network inference model.

15. The non-transitory machine-readable medium of claim 14, wherein the updated set of weights is optimized so that output generated by the first portion of the neural network inference model and output generated by the second portion of the neural network inference model substantially match.

16. The non-transitory machine-readable medium of claim 12, wherein the one-way function is a hash function.

17. A data processing system, comprising:
a processor; and
a memory coupled to the processor to store instructions, which when executed by the processor, cause the processor to perform operations for managing use of inference models, the operations comprising:
obtaining transformed input data, the transformed input data being generated using input data and a one-way function to reduce a level of sensitivity of the input data and the level of sensitivity indicating a level of impact of unauthorized access to the input data;
generating, using the transformed input data and an input data attack resistant inference model, a reconstruction resistant inference, the input data attack resistant inference model being trained to ingest the transformed input data so that inferences generated by the input data attack resistant inference model have a reduced likelihood of being usable to reconstruct the input data; and
providing computer-implemented services based on the reconstruction resistant inference.

18. The data processing system of claim 17, wherein the operations further comprise:
prior to obtaining the transformed input data:
obtaining a first training dataset, the first training dataset comprising a set of input features and labels for the input features;
obtaining a second training dataset, the second training dataset comprising transformed input features and the labels, the transformed input features being generated using the set of the input features and the one-way function;
performing a co-training process for a neural network inference model using the first training dataset and the second training dataset, the neural network inference model comprising:
a first portion of the neural network inference model, the first portion being trained using the first training dataset to predict the labels; and
a second portion of the neural network inference model, the second portion being trained using the second training dataset to predict the labels; and
using the second portion of the neural network inference model as the input data attack resistant inference model.

19. The data processing system of claim 18, wherein performing the co-training process comprises:
performing an optimization process for the first portion of the neural network inference model and the second portion of the neural network inference model using an objective function to obtain an updated set of weights for the neural network inference model.

20. The data processing system of claim 19, wherein the updated set of weights is optimized so that output generated by the first portion of the neural network inference model and output generated by the second portion of the neural network inference model substantially match.
